(19) United States
(12) Patent Application Publication
(10) Pub. No.: US 2024/0357970 A1
(43) Pub. Date: Oct. 31, 2024

(54) OUTDOOR TOOL AND BLADE

(71) Applicant: Milwaukee Electric Tool Corporation, Brookfield, WI (US)

(72) Inventors: Casey Garces, Brookfield, WI (US); Marcus Jenkins, Brookfield, WI (US); David Marolla, Brookfield, WI (US); Adam Czerwonka, Brookfield, WI (US); John Whealon, Brookfield, WI (US); Kyle Marten, Brookfield, WI (US)

(21) Appl. No.: 18/645,692

(22) Filed: Apr. 25, 2024

Related U.S. Application Data
(60) Provisional application No. 63/462,042, filed on Apr. 26, 2023.

(51) Int. Cl. A01G 3/06

(52) U.S. Cl. CPC A01G 3/062

(57) ABSTRACT

Outdoor tools such as a rotary cutter, and blades for a rotary cutter, are provided. A blade includes a body having a first side and a second side both extending from a first end to a second end of the body, a first edge and a second edge extending along a length of the body between the first side and the second side from the first end to the second end. The body includes a first arm, a second arm, and a planar portion between the first arm and the second arm. The blade is configured to rotate about a rotational axis that extends through the planar portion. The body further includes a hole surrounding the rotational axis. Each of the first arm and the second arm includes at least one bend. The body is symmetrical about at least one axis of symmetry.

### CROSS-REFERENCE TO RELATED APPLICATIONS

The present application claims priority to U.S. Provisional Patent Application No. 63/462,042 filed on Apr. 26, 2023, the disclosure of which is incorporated by reference herein in its entirety.

### FIELD

The present disclosure relates generally to outdoor tools such as rotary cutters, e.g., bed redefiners, that are used to cut trenches in the ground, and specifically to blades for such outdoor tools.

### BACKGROUND

In the landscaping business a common task is to edge around landscaping, e.g., to make a precise transition between landscape areas such as lawn areas and flower beds and/or mulch beds. Commonly, this line is defined by cutting a trench at the transition between landscape areas. This may produce an aesthetically pleasing. sharp, dividing line between the different types of landscape. This can be carried out by a machine having a blade rotated vertically by a motor driven shaft on which it is mounted. The shape and geometry of the blade may influence the shape and size of the trench, as well as the runtime and efficiency of the outdoor tool. Optimization of the efficiency of a rotary cutter outdoor tool may be necessary to improve runtime of the outdoor tool while maintaining performance, i.e., effective trench cutting, of the tool.

Accordingly, improved outdoor rotary cutting tools and blades therefor are desired in the art. In particular, outdoor tools and blades therefor which provide improved runtime and efficiency would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a blade is provided. The blade includes a body having a first side and a second side opposite the first side, the first side and the second side both extending from a first end to a second end of the body, a first edge extending along a length of the body between the first side and the second side from the first end to the second end, and a second edge extending along a length of the body between the first side and the second side from the first end to the second end. The body includes a first arm, a second arm, and a planar portion between the first arm and the second arm. The blade is configured to rotate about a rotational axis that extends through the planar portion. The body further includes a hole surrounding the rotational axis. Each of the first arm and the second arm includes at least one bend. The body is symmetrical about at least one axis of symmetry.

In accordance with another embodiment, an outdoor tool is provided. outdoor tool includes a power head and a tool attachment. The power head includes a power head housing, a power source, a motor powered by the power source, and a drive shaft extending from the motor and rotatably driven by the motor. The power source and the motor are disposed within the power head housing and the drive shaft extends from the power head housing. The tool attachment includes a blade, a guard disposed on one side of the blade, and a wheel. The drive shaft is coupled to the blade and is configured to drive rotation of the blade about a rotational axis of the blade. The blade includes a body having a first side and a second side opposite the first side, the first side and the second side both extending from a first end to a second end of the body, a first edge extending along a length of the body between the first side and the second side from the first end to the second end, and a second edge extending along a length of the body between the first side and the second side from the first end to the second end. The body includes a first arm, a second arm, and a planar portion between the first arm and the second arm. The rotational axis of the blade extends through the planar portion. The body further includes a hole surrounding the rotational axis. Each of the first arm and the second arm comprises at least one bend.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a side view of an outdoor tool including a rotary cutter in accordance with embodiments of the present disclosure;

FIG. 2 is a perspective view of a rotary cutter blade in accordance with embodiments of the present disclosure;

FIG. 3 is a top view of a rotary cutter blade in accordance with embodiments of the present disclosure;

FIG. 4 is a side view of a rotary cutter blade in accordance with embodiments of the present disclosure;

FIG. 5 is a perspective view of another rotary cutter blade in accordance with embodiments of the present disclosure; and

FIG. 6 is a perspective view of another rotary cutter blade in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising.” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a rotary cutter and embodiments of a blade for a rotary cutter. The rotary cutter may be a part of a modular outdoor tool having a power head coupled to a tool attachment including the rotary cutter. The rotary cutter may be used as a bed redefiner, and the blade may be referred to as a bed redefiner blade. The blade may have a wing-shaped arrangement and/or a V-shaped arrangement. The blade may be symmetrical about one or more axes of symmetry extending through a rotational axis of the blade.

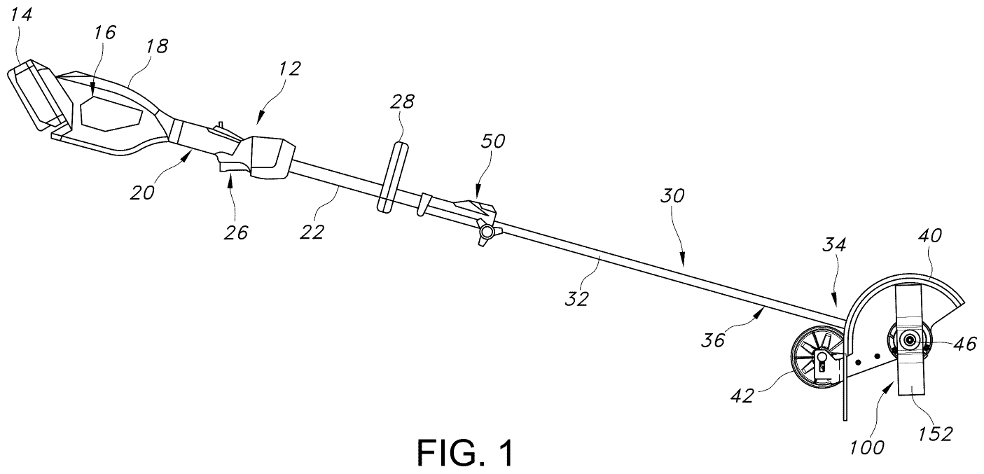

Referring now to the drawings, FIG. 1 illustrates an outdoor tool 10 in accordance with an exemplary embodiment. The outdoor tool 10 may be an outdoor power tool including a power head 12 and a tool attachment 30, e.g., a rotary cutter. Generally, the power head 12 may be coupled to the tool attachment 30 to power a tool of the tool attachment 30.

Now describing the power head 12 in more detail, the power head 12 includes a power source 14, e.g., a battery, and a motor 16. The power source 14 and motor 16 may be disposed in a power head housing 18. The motor 16 is powered by the power source 14. When powered by the power source 14, rotation of the motor 16 is configured to rotatably drive a drive shaft 20, i.e., the drive shaft 20 is rotatably driven by the motor 16. The power head drive shaft 20 is configured to extend from the power head housing 18. The power head drive shaft 20 may be disposed within an outer protective shaft 22. The power head drive shaft 20 and/or the outer protective shaft 22 may include one or more coupling features 24 configured to couple to a receiver 50 of the tool 30. The outer protective shaft 22 may further include a user input 26, e.g., a power switch, configured to control operation of the power head 12, and a handle 28 configured to be grasped by a user.

The tool attachment 30 includes a shaft 32 and a tool head 34, e.g., a rotary cutter as shown in FIG. 1. A tool drive shaft 36 passes through the shaft 32 and drives the rotary cutter 34, specifically, a blade 100, in rotation about a rotational axis 122 via a transmission (not shown). The rotational axis 122 extends perpendicularly to a longitudinal direction of the shaft 32. Further, the rotational axis 122 extends generally parallel to the ground or surface to be cut by the rotary cutter 34. A fastener 46 may couple the blade 100 to the transmission and may extend along the rotational axis 122. The blade 100 is partially covered by a protective guard 40. The protective guard 40 is disposed between the blade 100 and the shaft 32, and extends predominantly on a side of the blade 100 that faces an operator of the outdoor tool 10. Stated differently, the protective guard 40 extends generally in front of and above the blade 100 with respect to a direction of movement. The rotary cutter 34 further includes a wheel 42 that is configured to roll over the ground or surface to be cut during operation to guide the outdoor tool 10 during operation. Optionally, a spray guard 44 may be provided with the protective guard 40.

The power source 14 of the outdoor tool 10 may be a battery, or the outdoor tool 10 may be gas-powered, electrically powered by a wired source of electricity, or powered by other suitable means. In one embodiment, the power source 14 may be an 18V battery.

The motor 16 may drive the blade 100 to rotate as described above. The blade 100 may be rotated at a frequency of from about 1000 revolutions per minute (RPM) to about 3000 RPM, such as from about 1500 RPM to about 2500 RPM. In one embodiment, the blade 100 may be rotated at a frequency of about 2000 RPM. The transmission of the rotary cutter 34 may have a gear ratio in a range from about 3 to about 5, such as from about 3.5 to about 4.5. In one embodiment, the gear ratio may be about 4.3. When the rotary cutter 34 is driven by the motor 16 and powered by an 18V battery power source 14, and the transmission gear ratio is about 4.3 such that the blade 100 is rotated at about 2000 RPM, the outdoor tool 10 may have a no load runtime of about 90 to about 100 minutes before the 18V battery runs out of power. When compared to existing rotary cutter tools, e.g., bed redefiners, which operate powered by a higher voltage battery and at a gear ratio of about 2.0 and about 4000-4500 RPM, the outdoor tool 10 of the present invention may increase the no load runtime by about one and a half times to two times (1.5-2×). Thus, the outdoor tool 10 of the present invention may provide superior no load runtime and efficiency, even when powered by a lower voltage battery, as compared to existing bed redefiners.

During operation of the outdoor tool 10, the blade 100 of the rotary cutter 34 creates a trench or furrow in the ground. For instance, the blade 100 of the rotary cutter 34 may be used to create a trench or furrow between a lawn area and a bed area such that the rotary cutter 34 is used as a bed redefiner. The trench extends perpendicularly to the surface of the ground. A cross-sectional shape of the trench may be determined by the shape of the blade 100, which will be discussed in further detail below.

While FIG. 1 illustrates a rotary cutter as a tool attachment 30 coupled with the power head 12 to form the outdoor tool 10, the tool attachment 30 may be any desirable outdoor tool that is selectively and removably coupled to the power head 12, including but not limited to a string trimmer attachment, an edger attachment, a hedge trimmer attachment, a pole saw attachment, a brush cutter attachment, a blower attachment, a broom attachment, a brush attachment, a cultivator attachment, or the like. Moreover, the outdoor tool 10 may be provided with a plurality of additional tool attachments 30 to form a kit of interchangeable tools usable with the power head 12.

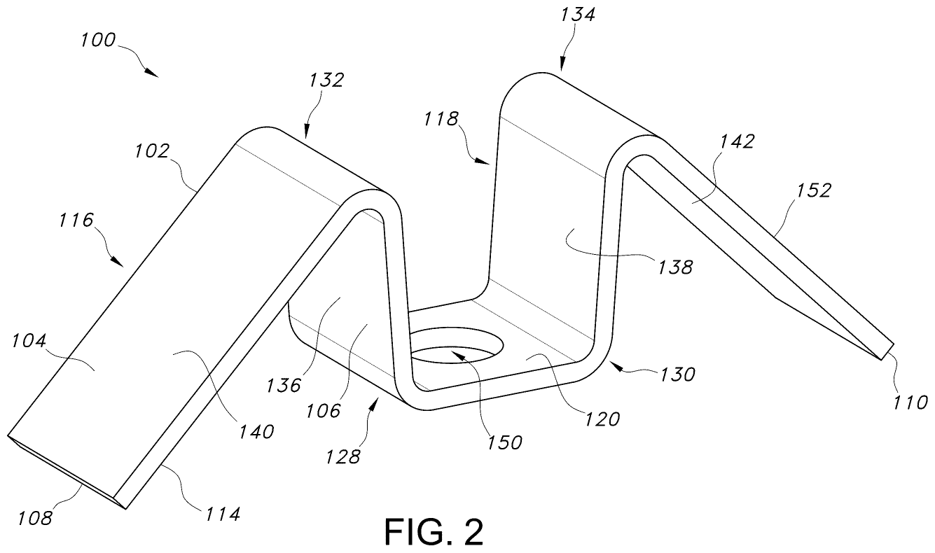

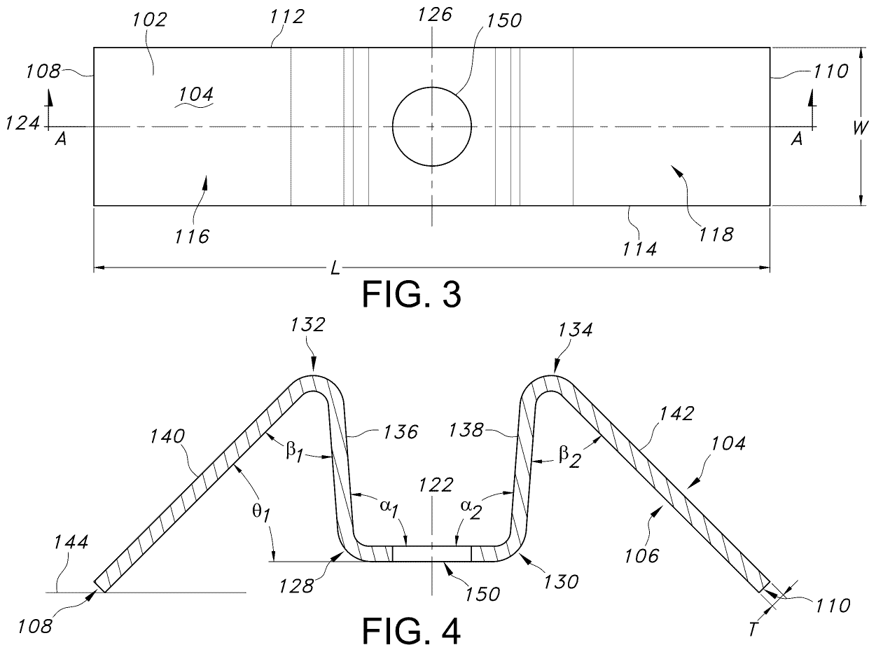

Turning now to FIGS. 2-4, the blade 100 will be described in detail. The blade 100 has a body 102. The body 102 may be formed of one-piece construction. The body 102 has a first side 104 and a second side 106 opposite the first side. The first side 104 and second side 106 extend between a first end 108 and a second end 110 along a length L of the body 102, and between a first edge 112 and a second edge 114 along a width W of the body 102. The first edge 112 and second edge 114 have a thickness T extending between the first side 104 and second side 106. The blade 100 may have a maximum height H measured from an innermost point of the second side 106 of the body 102 to an outermost part of the first side 104 of the body 102 relative to a rotational axis 122. In some arrangements, the first side 104 may form an outer side of the blade 100, i.e., facing away from the protective guard 40, and the second side 106 may form an inner side of the blade.

The length L may be in a range from about 150 mm to about 300 mm, such as from about 175 mm to about 250 mm, such as from about 210 mm to about 230 mm. The width W may be in a range from about 30 mm to about 70 mm, such as from about 40 mm to about 60 mm, such as from about 45 mm to about 55 mm. The thickness T may be in a range from about 3 mm to about 7 mm. The maximum height H of the blade 100 may be in a range from about 50 mm to about 100 mm, such as from about 60 mm to about 90 mm, such as from about 65 mm to about 75 mm. A ratio of the length L to the height H of the blade 100 may be in a range from about 2:1 to about 4:1, such as from about 2.5:1 to about 3.5:1. A ratio of the length L to the width W of the blade 100 may be in a range from about 3:1 to about 6:1, such as from about 3.5:1 to about 5:1. A ratio of the height H to the width W of the blade 100 may be in a range from about 1:1 to about 2:1, such as from about 1.25:1 to about 1.75:1.

The maximum height H of the blade 100 measured parallel to the rotational axis 122 may generally correspond to a depth of a trench cut by the blade 100 in operation of the rotary cutter 34.

In some aspects of the present invention, as illustrated in FIG. 2, the first side 104 and second side 106 may be generally perpendicular to the first edge 112 and second edge 114. Similarly, the first side 104 and second side 106 may be generally perpendicular to the first end 108 and second end 110.

The body 102 of the blade 100 includes a first arm 116, e.g., a first cutting arm, a second arm 118, e.g., a second cutting arm, and a planar portion 120. The second side 106 of the planar portion 120 may lie in a horizontal axis 144. The planar portion 120 may be disposed between the first arm 116 and the second arm 118. The first arm 116 may be disposed adjacent to the first end 108 and the second arm may be disposed adjacent to the second end 110 of the body 102.

A rotational axis 122 of the blade 100 extends through the planar portion 120 from the first side 104 to the second side 106 of the body 102. For instance, the rotational axis 122 may be perpendicular to both the first side 104 and the second side 106 of the body 102. A fastener opening 150 may be formed in the planar portion 120. The fastener opening 150 may extend through the body 102 from the first side 104 to the second side 106. The fastener opening 150 may be formed about the rotational axis 122. For instance, the fastener opening 150 may have a circular shape, and the rotational axis 122 may be disposed at the center of the circular shape of the fastener opening 150. In this manner, the fastener 46 of the rotary cutter 34 may extend through the blade 100 and coincide with the rotational axis 122.

When the blade 100 is rotated about the rotational axis 122, portions of the first edge 112 and/or the second edge 114 may form cutting surfaces 252. The cutting surface(s) 252 may be generally perpendicular to the first side 104 and second side 106 of the blade 100, as illustrated in FIG. 2. However, the present inventors further contemplate embodiments in which one or more of the cutting surface(s) may form an angle, e.g., an acute angle, with respect to one or more of the first side 104 and the second side 106.

In some aspects of the present invention, the blade 100 may have at least one axis of symmetry. For instance, a first axis of symmetry 124 may extend along a length L of the blade 100 from the first end 108 to the second end 110 intersecting with the rotational axis 122. The first axis of symmetry 124 may be generally perpendicular to the rotational axis 122.

A second axis of symmetry 126 may extend along a width W of the blade 100 between the first edge 112 to the second edge 114 through the rotational axis 122. The second axis of symmetry 126 may be generally perpendicular to the rotational axis 122. In this regard, each of the first axis of symmetry 124, second axis of symmetry 126, and the rotational axis 122 may be orthogonal to each other.

The first arm 116 may be bent away from the planar portion 120 at a first bend of the first arm 128. The first bend of the first arm 128 may be bent in a direction configured to be disposed away from the protective guard 40 when the blade 100 is arranged on the rotary cutter 34. The first bend of the first arm 128 may form an angle α₁ with the first side 104 of the planar portion 120. The angle α₁ may be in a range from about 70 degrees to about 120 degrees, such as from about 90 degrees to about 100 degrees, for instance, about 95 degrees.

The first arm 116 may further include a second bend of the first arm 132. The second bend of the first arm 132 may be disposed between the first end 108 and the first bend of the first arm 128. The second bend of the first arm 132 may separate an inner portion 136 of the first arm 116, which is nearer to the planar portion 120, from an outer portion of the first arm 140, which is nearer to the first end 108. The second bend of the first arm 132 may bend the outer portion 140 of the first arm back in a direction toward the horizontal axis 144. The second bend of the first arm 132 may form an angle β₁ between the inner portion of the first arm 136 and the outer portion of the first arm 140 along the second side 106 of the body. The angle β₁ may be in a range from between about 40 to about 60 degrees, such as from about 45 degrees to about 55 degrees.

In some aspects of the present invention, as a result of the outer portion of the first arm 140 being bent at the angle β₁ relative to the inner portion of the first arm 136, the outer portion of the first arm 140 may form an angle θ₁ with the horizontal axis 144. The angle θ₁ may be in a range from about 35 degrees to about 55 degrees, such as from about 40 degrees to about 50 degrees, for instance, about 45 degrees. In some aspects, the first end 108 may intersect the horizontal axis 144, e.g., may extend through the horizontal axis 144.

As previously described, the blade 100 may be symmetrical about a first axis of symmetry 124 and a second axis of symmetry 126. As such, the second arm 118 of the blade 100 may be symmetrical to the first arm 116 of the blade 100. The symmetrical elements of the second arm 118 of the blade 100 will now be described.

The second arm 118 may be bent away from the planar portion 120 at a first bend of the second arm 130. The first bend of the second arm 130 may be bent in a direction configured to be disposed away from the protective guard 140 when the blade 100 is arranged on the rotary cutter 34. The first bend of the second arm 130 may form an angle α₂ with the first side 104 of the planar portion 120. The angle α₂ may be in a range from about 70 degrees to about 120 degrees, such as from about 90 degrees to about 100 degrees, for instance, about 95 degrees.

The second arm 118 may further include a second bend of the second arm 134. The second bend of the second arm 134 may be disposed between the second end 110 and the first bend of the second arm 130. The second bend of the second arm 134 may separate an inner portion 138 of the second arm 118, which is nearer to the planar portion 120, from an outer portion of the second arm 142, which is nearer to the second end 110. The second bend of the second arm 134 may bend the outer portion of the second arm 142 back in a direction toward the horizontal axis 144. The second bend of the second arm 134 may form an angle β₂ between the inner portion of the second arm 138 and the outer portion of the second arm 142 along the second side 106 of the body. The angle β₂ may be in a range from between about 40 to about 60 degrees, such as from about 45 degrees to about 55 degrees.

In some aspects of the present invention, as a result of the outer portion of the second arm 142 being bent at the angle β₂ relative to the inner portion of the second arm 138, the outer portion of the second arm 142 may form an angle θ₂ with the horizontal axis 144. The angle θ₂ may be in a range from about 35 degrees to about 55 degrees, such as from about 40 degrees to about 50 degrees, for instance, about 45 degrees. In some aspects, the second end 110 may intersect the horizontal axis 144, e.g., may extend through the horizontal axis 144.

As described above and as illustrated in, e.g., FIGS. 2 and 4, the respective bends of the first arm 116 and second arm 118 may result in a blade 100 having the appearance of wings or a wing shape on either side of the planar portion 120 where the rotational axis 122 is disposed.

As a result of the symmetry of the blade 100 as described above, a leading edge of the blade 100 when the blade 100 is rotated in a clockwise direction about the rotational axis 122 may be identical to a leading edge of the blade 100 when the blade 100 is rotated in a counter-clockwise direction about the rotational axis 122.

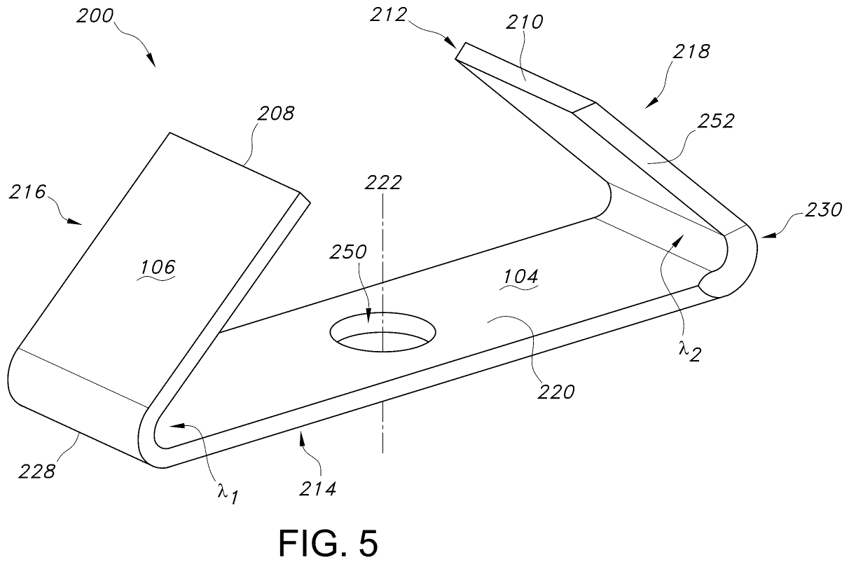

FIG. 5 illustrates an embodiment of a blade 200 in accordance with the present invention. The blade 200 has a body 202. The body 202 may be formed of one-piece construction. The body 202 has a first side 204 and a second side 206 opposite the first side. The first side 204 and second side 206 extend between a first end 208 and a second end 210, and between a first edge 212 and a second edge 214.

The body 202 of the blade 200 includes a first arm 216, e.g., a first cutting arm, a second arm 218, e.g., a second cutting arm, and a planar portion 220. The planar portion 220 may be disposed between the first arm 216 and the second arm 218. The first arm 216 may be disposed adjacent to the first end 208 and the second arm may be disposed adjacent to the second end 210 of the body 202.

A rotational axis 222 of the blade 200 extends through the planar portion 220 from the first side 204 to the second side 206 of the body 202. For instance, the rotational axis 222 may be perpendicular to both the first side 204 and the second side 206 of the body 202. A fastener opening 250 may be formed in the planar portion 220. The fastener opening 250 may extend through the body 202 from the first side 204 to the second side 206. The fastener opening 250 may be formed about the rotational axis 222. For instance, the fastener opening 250 may have a circular shape, and the rotational axis 222 may be disposed at the center of the circular shape of the fastener opening 250. In this manner, the fastener 46 of the rotary cutter 34 may extend through the blade 200 and coincide with the rotational axis 222.

The first arm 216 may be bent from the planar portion 220 at a first bend of the first arm 228. The first bend of the first arm 228 may be bent in a direction configured to be disposed away from the protective guard 40 when the blade 200 is arranged on the rotary cutter 34. The first bend of the first arm 228 may form an angle λ₁ with the first side 204 of the planar portion 220. The angle λ₁ may be in a range from about 25 degrees to about 75 degrees, such as from about 30 degrees to about 60 degrees, for instance, about 45 degrees.

The second arm 218 may be bent from the planar portion 220 at a first bend of the second arm 230. The first bend of the second arm 230 may be bent in a direction configured to be disposed away from the protective guard 40 when the blade 200 is arranged on the rotary cutter 34. The first bend of the second arm 230 may form an angle λ₂ with the first side 204 of the planar portion 220. The angle λ₂ may be in a range from about 25 degrees to about 75 degrees, such as from about 30 degrees to about 60 degrees, for instance, about 45 degrees.

As illustrated in FIG. 5, the first end 208 and the second end 210 of the body 202 are bent toward the rotational axis 222 such that the first end 208 and the second end 210 are disposed nearer to the rotational axis 222 than the first bend of the first arm 228 and the first bend of the second arm 230.

The blade 200 may further have one or more angled cutting surfaces 252. The angled cutting surfaces 252 may be formed along the first edge 212 and/or second edge 214. The angled cutting surfaces 252 may be adjacent to the first end 208 and/or second end 210. For instance, an angled cutting surface 252 may be formed on the second edge 214 along the second arm 218 between the planar portion 220 and the second end 210. Additional angled cutting surfaces 252 may be similarly disposed on the first edge 212 along the second arm 218 and/or on the first edge 212 and/or second edge 214 along the first arm 216. The angled cutting surfaces 252 may form an acute angle between the second side 206 and the respective first edge 212 or second edge 214.

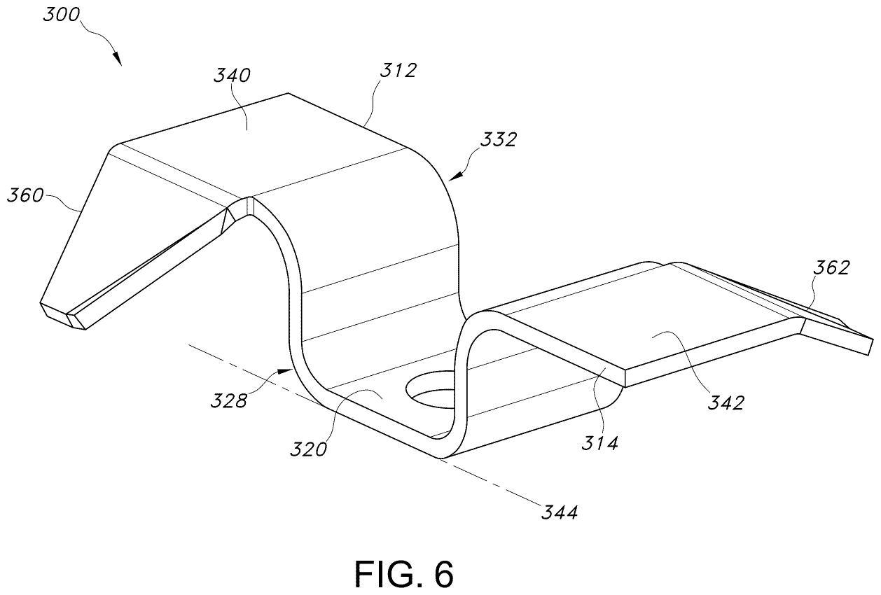

FIG. 6 illustrates an embodiment of a blade 300 in accordance with the present invention. The blade 300 may have a wing-shaped configuration similar to the blade 100. Similar reference numerals will be used for analogous features of the blade 300.

As shown in FIG. 6, the blade 300 has a first arm 316 and a second arm 318. The first arm 316 includes a first bend 328 and a second bend 332. The outer portion of the first arm 340 further includes a cutting wing 360 extending therefrom. The cutting wing 360 may extend from the second edge 314 of the body 302 of the blade 300. The cutting wing 360 may extend at a non-zero angle relative to the outer portion 340, as shown in FIG. 6, or the cutting wing 360 may be generally parallel to the outer portion 340. For instance, the cutting wing 360 may extend generally downward at an angle in a direction of a horizontal plane 344. The cutting wing 360 may taper away from the outer portion 340 as shown in FIG. 6.

Similarly, the outer portion of the second arm 342 may further include a second cutting wing 362 extending therefrom. The second cutting wing 362 may extend from the first edge 312 of the body 302 of the blade 300. The second cutting wing 362 may extend at a non-zero angle relative to the outer portion 342, as shown in FIG. 6, or the second cutting wing 362 may be generally parallel to the second outer portion 342. For instance, the second cutting wing 362 may extend generally downward at an angle in a direction of a horizontal plane 344. The second cutting wing 362 may taper away from the outer portion 342 as shown in FIG. 6.

The cutting wings 360 and 362 of the blade 300 may assist with redirecting dirt, debris or other material cut or redirected from the ground away from a trench that is cut by the rotary cutter. For instance, the cutting wings 360 and 362 may be disposed on a trailing edge of the blade 300 during rotation of the blade 300 during a cutting operation. However, a direction of the blade 300 may be reversed such that the cutting wings 360 and 362 may alternatively be disposed on a leading edge of the blade 300 during rotation.

Further aspects of the invention are provided by one or more of the following embodiments:

A blade includes a body having a first side and a second side opposite the first side, the first side and the second side both extending from a first end to a second end of the body, a first edge extending along a length of the body between the first side and the second side from the first end to the second end, and a second edge extending along a length of the body between the first side and the second side from the first end to the second end. The body includes a first arm, a second arm, and a planar portion between the first arm and the second arm. The blade is configured to rotate about a rotational axis that extends through the planar portion. The body further includes a hole surrounding the rotational axis. Each of the first arm and the second arm includes at least one bend. The body is symmetrical about at least one axis of symmetry.

The blade of any one or more of the embodiments, wherein the at least one axis of symmetry comprises a first axis of symmetry and a second axis of symmetry, wherein the body is symmetrical about both the first axis of symmetry and the second axis of symmetry.

The blade of any one or more of the embodiments, wherein the first axis of symmetry is orthogonal to the second axis of symmetry.

The blade of any one or more of the embodiments, wherein the first axis of symmetry and the second axis of symmetry are orthogonal to the rotational axis.

The blade of any one or more of the embodiments, wherein the first edge and the second edge are generally perpendicular to the first side and second side of the body.

The blade of any one or more of the embodiments, wherein the first edge and the second edge are symmetrical.

The blade of any one or more of the embodiments, wherein a leading edge of the blade when the blade is rotated in a clockwise direction about the rotational axis is identical to a leading edge of the blade when the blade is rotated in a counter-clockwise direction about the rotational axis.

The blade of any one or more of the embodiments, wherein the at least one bend of the first arm comprises a first bend and a second bend.

The blade of any one or more of the embodiments, wherein the first bend is disposed at an angle α₁ of between about 70 degrees and 110 degrees with respect to the planar portion.

The blade of any one or more of the embodiments, wherein the angle α₁ is between about 85 degrees and about 100 degrees.

The blade of any one or more of the embodiments, wherein the second bend is disposed between the first end and the first bend, wherein the first arm comprises an inner portion disposed between the first bend and the second bend and an outer portion between the first end and the second bend.

The blade of any one or more of the embodiments, wherein the second bend is disposed at an angle β₁ of between about 40 and about 60 degrees with respect to the inner portion.

The blade of any one or more of the embodiments, wherein the planar portion of the second side of the body is disposed in a horizontal plane, further wherein the first end of the second side and the second end of the second side intersect the horizontal plane.

The blade of any one or more of the embodiments, wherein the outer portion is disposed at an angle of between about 35 degrees and about 55 degrees with respect to the horizontal plane.

The blade of any one or more of the embodiments, further comprising a cutting wing extending from the outer portion of the first arm.

The blade of any one or more of the embodiments, wherein the cutting wing extends from the second edge of the outer portion of the first arm, further wherein the cutting wing is not parallel with the outer portion of the first arm.

The blade of any one or more of the embodiments, wherein the at least one bend of each of the first arm and the second arm comprises an acute angle such that each of the first end and the second end are bent towards the rotational axis.

The blade of any one or more of the embodiments, wherein the first edge of the first arm forms an acute angle with the second side of the body.

An outdoor tool includes a power head and a tool attachment. The power head includes a power head housing, a power source, a motor powered by the power source, and a drive shaft extending from the motor and rotatably driven by the motor. The power source and the motor are disposed within the power head housing and the drive shaft extends from the power head housing. The tool attachment includes a blade, a guard disposed on one side of the blade, and a wheel. The drive shaft is coupled to the blade and is configured to drive rotation of the blade about a rotational axis of the blade. The blade includes a body having a first side and a second side opposite the first side, the first side and the second side both extending from a first end to a second end of the body, a first edge extending along a length of the body between the first side and the second side from the first end to the second end, and a second edge extending along a length of the body between the first side and the second side from the first end to the second end. The body includes a first arm, a second arm, and a planar portion between the first arm and the second arm. The rotational axis of the blade extends through the planar portion. The body further includes a hole surrounding the rotational axis. Each of the first arm and the second arm comprises at least one bend.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A blade comprising:
a body having a first side and a second side opposite the first side, the first side and the second side both extending from a first end to a second end of the body, a first edge extending along a length of the body between the first side and the second side from the first end to the second end, and a second edge extending along a length of the body between the first side and the second side from the first end to the second end,
the body comprising a first arm, a second arm, and a planar portion between the first arm and the second arm,
wherein the blade is configured to rotate about a rotational axis that extends through the planar portion,
the body further comprising a hole surrounding the rotational axis,
wherein each of the first arm and the second arm comprises at least one bend, and
wherein the body is symmetrical about at least one axis of symmetry.

2. The blade of claim 1, wherein the at least one axis of symmetry comprises a first axis of symmetry and a second axis of symmetry, wherein the body is symmetrical about both the first axis of symmetry and the second axis of symmetry.

3. The blade of claim 2, wherein the first axis of symmetry is orthogonal to the second axis of symmetry.

4. The blade of claim 3, wherein the first axis of symmetry and the second axis of symmetry are orthogonal to the rotational axis.

5. The blade of claim 1, wherein the first edge and the second edge are generally perpendicular to the first side and second side of the body.

6. The blade of claim 5, wherein the first edge and the second edge are symmetrical.

7. The blade of claim 6, wherein a leading edge of the blade when the blade is rotated in a clockwise direction about the rotational axis is identical to a leading edge of the blade when the blade is rotated in a counter-clockwise direction about the rotational axis.

8. The blade of claim 1, wherein the at least one bend of the first arm comprises a first bend and a second bend.

9. The blade of claim 8, wherein the first bend is disposed at an angle α₁ of between about 70 degrees and 110 degrees with respect to the planar portion.

10. The blade of claim 9, wherein the angle α₁ is between about 85 degrees and about 100 degrees.

11. The blade of claim 8, wherein the second bend is disposed between the first end and the first bend, wherein the first arm comprises an inner portion disposed between the first bend and the second bend and an outer portion between the first end and the second bend.

12. The blade of claim 11, wherein the second bend is disposed at an angle β₁ of between about 40 and about 60 degrees with respect to the inner portion.

13. The blade of claim 11, wherein the planar portion of the second side of the body is disposed in a horizontal plane, further wherein the first end of the second side and the second end of the second side intersect the horizontal plane.

14. The blade of claim 13, wherein the outer portion is disposed at an angle of between about 35 degrees and about 55 degrees with respect to the horizontal plane.

15. The blade of claim 13, further comprising a cutting wing extending from the outer portion of the first arm.

16. The blade of claim 15, wherein the cutting wing extends from the second edge of the outer portion of the first arm, further wherein the cutting wing is not parallel with the outer portion of the first arm.

17. The blade of claim 1, wherein the at least one bend of each of the first arm and the second arm comprises an acute angle such that each of the first end and the second end are bent towards the rotational axis.

18. The blade of claim 17, wherein the first edge of the first arm forms an acute angle with the second side of the body.

19. An outdoor tool comprising:
a power head comprising a power head housing, a power source, a motor powered by the power source, and a drive shaft extending from the motor and rotatably driven by the motor, wherein the power source and the motor are disposed within the power head housing and the drive shaft extends from the power head housing; and
a tool attachment comprising a blade, a guard disposed on one side of the blade, and a wheel, wherein the drive shaft is coupled to the blade and is configured to drive rotation of the blade about a rotational axis of the blade;
wherein the blade comprises a body having a first side and a second side opposite the first side, the first side and the second side both extending from a first end to a second end of the body, a first edge extending along a length of the body between the first side and the second side from the first end to the second end, and a second edge extending along a length of the body between the first side and the second side from the first end to the second end,
the body comprising a first arm, a second arm, and a planar portion between the first arm and the second arm,
wherein the rotational axis of the blade extends through the planar portion,
the body further comprising a hole surrounding the rotational axis,
wherein each of the first arm and the second arm comprises at least one bend.
